(19) United States
(12) Patent Application Publication
(10) Pub. No.: US 2021/0139376 A1
(43) Pub. Date: May 13, 2021

(54) MATERIALS WITH HIERARCHICAL NANOCHEMICAL BONDING, MANUFACTURING METHODS AND APPLICATIONS OF SAME

(71) Applicant: QuShell LLC, Rogers, AR (US)

(72) Inventor: Zheng R. Tian, Rogers, AR (US)

(21) Appl. No.: 17/096,334

(22) Filed: Nov. 12, 2020

Related U.S. Application Data
(60) Provisional application No. 62/934,210, filed on Nov. 12, 2019.

(51) Int. Cl. C04B 35/053; C04B 35/057; C04B 22/06

(52) U.S. Cl. CPC C04B 35/053; C04B 35/057; B82Y 30/00; C04B 22/064; C04B 22/066

(57) ABSTRACT

A method of manufacturing a composition with hierarchical nanochemical bonding includes making a powder of one or more oxygen containing materials; mixing the powder either with a water solution of organic and/or inorganic acid to form an acidic slurry, or with water to form a hydrated basic slurry; and curing the slurry to form a solid. The powder comprises nanoscale particles, or microscale particles, or a mixture of nanoscale particles and microscale particles.

### CROSS-REFERENCE TO RELATED PATENT APPLICATION

This application claims priority to and the benefit of, pursuant to 35 U.S.C. § 119(e), U.S. Provisional Patent Application Ser. No. 62/934,210, filed Nov. 12, 2019, which is incorporated herein in their entirety by reference.

### FIELD

The disclosure relates generally to material science, and more particularly, to compositions/materials with hierarchical nanochemical bonding, manufacturing methods and applications of same.

### BACKGROUND

A wide variety of materials are known, as are their methods of manufacture and use, including cement and ceramics. However, these conventional materials and methods have a wide variety of drawbacks and limitations. Hence, there is a long-standing frustrated need to improve the body of known materials and methods, including the need to improve cements and ceramic-like materials.

### SUMMARY

Various embodiments include improved formulations involving the hierarchical nanochemical bonding of nanosized and micron-sized materials, and methods to manufacture and use such materials, including cement and ceramic-like materials.

In one aspect, the disclosure relates to a method of manufacturing a material. The method includes making a powder of one or more oxygen containing minerals; mixing the powder either with a water solution of organic and/or inorganic acid to form an acidic slurry, or with water to form a hydrated basic slurry; and curing the slurry to form a solid. In one embodiment, the powder comprises nanoscale particles, or microscale particles, or a mixture of nanoscale particles and microscale particles.

In one embodiment, the one or more oxygen containing minerals are members of the group including sulfates, phosphates, carbonates, silicates, limestone, granite, other minerals, and aluminosilicates of magnesium, or of calcium, or of other minerals. In one embodiment, the powder consists of nanoscale particles with an average particle size of 2 to 3 nanometers.

In one embodiment, the method further includes after the slurry is formed and before it is cured into a solid, adding one or more other materials to the slurry. Optionally, the one or more other materials are members of the group including powders, fibers, steel rebars, sheets of polymer, glass, carbon materials, carbon fibers, and glass fibers.

In one embodiment, the method further includes after the slurry is formed, and before it is cured into a solid, coating a surface with the slurry; and curing the slurry coating to form a solid coating on the coated surface. Optionally, the surface is a surface of a material that is a member of the group including metal, polymer, glass, ceramic, concrete, steel reinforced concrete, carbon fiber, and other material.

In one embodiment the surface is the surface of a component of infrastructure. The infrastructure is a member of the group including buildings, skyscrapers, bridges, airports, roads, and other infrastructure.

In one embodiment, the coated surface is the interior surface of a drilled hole for a well of oil, gas, or other resources, and the cured slurry forms a solid liner in the drilled hole for the well.

In one embodiment, the method further includes after the slurry is formed and before it is cured into a solid, pouring the slurry into a form in the shape of a component of infrastructure, wherein the infrastructure is a member of the group including buildings, skyscrapers, bridges, airports, roads, and other infrastructure.

In another aspect, the disclosure relates to a solid composition including a nanoscale powder of one or more oxygen containing materials, cured with either a water solution of organic and/or inorganic acid, or with water. The solid composition has at least one performance characteristic in the group including density less than conventional concrete, density less than 1.6 g/cm³, non-flammable, structurally stable above 700° celsius, compression strength from 3,000 psi to 13,000 psi, neutral pH or weakly acidic, and tensile strength greater than conventional concrete. The composition is resistant to one or more actions in the group comprising: corrosion, erosion, scratching, photobleaching, oxidation, indentation, penetration by oil or water, absorption of salts, dissolution, and swelling.

In one embodiment, the solid composition is bonded to one member of the group including concrete, steel rebar, glass fibers, carbon fibers, metal, polymer, or ceramic. In yet another aspect, the disclosure relates to a composition, comprising a chemical formula of

(MO)ᵤ.(M₂O₃)_{w}.(MO₂)ₓ.(M₂O₅)_{y}).(MO₃)_{z}.H₂O)ₙ

wherein each of u, w, x, y and z is in a range of 1-100, and n is in a range of 0-1000, wherein M represents a mineral including metal or nonmetal, and O represents oxygen.

In one embodiment, M in the M₂O₃ is any element with a +3 valence including cobalt, a rare earth, iron, or nickel.

In one embodiment, M in the MO is any element with a +2 valence including magnesium and calcium.

In one embodiment, M in the MO₂ is any element with a +4 valence including silicon, germanium, titanium, or zirconium.

In one embodiment, M in the M₂O₅ is any element with a +5 valence including vanadium, niobium, tantalum, antimony, arsenic, or phosphorous.

In one embodiment, M in the MO₃ is any element with a +6 valence including chromium, molybdenum, or tungsten.

In one embodiment, each of the MO, MO₂, M₂O₃, M₂O₅, and MO₃ are a monomer, a dimer, an oligomer, or a polymer.

These and other aspects of the disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flowchart of manufacturing a composition with hierarchical nanochemical bonding according to embodiments of the disclosure.

FIG. 2A is an illustration of hierarchical nanochemical bonding of the particles according to embodiments of the disclosure.

FIG. 2B is an illustration of hierarchical nanochemical bonding of the particles according to embodiments of the disclosure.

FIG. 2C is an illustration of bonding in the prior art.

FIG. 3A is an illustration of bonding of particles in the prior art.

FIG. 3B is an illustration of hierarchical nanochemical bonding of particles according to embodiments of the disclosure

FIG. 3C is an illustration of bonding of particles in the prior art.

FIG. 3D is an illustration of hierarchical nanochemical bonding of particles according to embodiments of the disclosure.

FIG. 4 is a flowchart of manufacturing a composition with hierarchical nanochemical bonding according to embodiments of the disclosure.

### DETAILED DESCRIPTION

The disclosure will now be described more fully hereinafter with reference to the accompanying drawings, in which exemplary embodiments of the disclosure are shown. The disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the disclosure or of any exemplified term. Likewise, the disclosure is not limited to various embodiments given in this specification.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the disclosure.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprise(s)” and/or “comprising,” or “include(s)” and/or “including” or “has (have)” and/or “having” or “contain(s)” and/or “containing” when used in this specification specify the presence of stated features, regions, integers, steps, operations, elements, and/or components, but do not preclude the presence or addition of one or more other features, regions, integers, steps, operations, elements, components, and/or groups thereof.

This disclosure describes various elements, features, aspects, and advantages of various embodiments, formulations, configurations, and arrangements of nanomaterial compositions, and methods for the same thereof. The disclosure and the new hierarchical nanochemical bonding science are not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. It is to be understood that certain descriptions of the various embodiments and such configurations and arrangements thereof have been simplified to illustrate only those elements, features and aspects that are relevant to a more clear understanding of the disclosed embodiments, while eliminating, for purposes of brevity or clarity, other elements, features and aspects. Any references to “various,” “certain,” “some,” “one,” or “an” when followed by “embodiment,” “configuration,” “example”, or “arrangement” generally means that a particular element, feature or aspect described in the example is included in at least one embodiment. The phrases “in various,” “in certain,” “in some,” “in one,” “in an,” “in a further,” or similar when followed by “embodiment,” “configuration,” “example,” or “arrangement” may not necessarily refer to the same embodiment. Furthermore, the phrases “in one such” or “in this” when followed by “embodiment,” “configuration,” “example,” or “arrangement,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. The conjunction “or” is generally used as inclusive, synonymous with the conjunction “and/or,” permitting either or more of two or more alternatives, but not to require that multiple alternatives exist.

It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the disclosure as defined solely by the claims.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated. Any numerical range recited herein includes all values from the lower value to the upper value. For example, if a concentration range is stated as 1% to 50%, it is intended that values such as 2% to 40%, 10% to 30%, or 1% to 3%, and the like, are expressly enumerated in this specification. These are only examples of what is specifically intended, and all possible combinations of numerical values between and including the lowest value and the highest value enumerated are to be considered to be expressly stated in this application. Numbers modified by the term “about” are intended to include +/−10% of the number modified.

The illustrations of arrangements described herein are intended to provide a general understanding of the structure of various embodiments, and they are not intended to serve as a complete description of all the elements and features of the embodiments described herein. While the present disclosure generally describes the inventive concept, those having skill in the art will appreciate that the embodiments, and disclosures described herein may find application in many industries. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the disclosure. Combinations of the above arrangements, and other arrangement not specifically described herein, will be apparent to those of skill in the art upon reviewing the above description. Therefore, it is intended that the disclosure not be limited to the particular arrangement(s) disclosed as the best mode contemplated for carrying out this disclosure, but that the disclosure will include all embodiments and arrangements falling within the scope of the appended claims.

The description below is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the disclosure.

Various embodiments include new improved nanosized and micron-sized materials which include quick- and slow-curing cements and ceramics that may be manufactured at ambient temperatures, and at ambient pressures. Various embodiments also involve related nanotechnology methods to manufacture and use such materials, including the hierarchical nanochemical bonding of such materials. Embodiments further include nanotechnology cements and ceramic-like materials, and nanotechnology methods to manufacture and use such materials, including the hierarchical nanochemical bonding of such materials. Various embodiments include improved formulations involving the hierarchical nanochemical bonding of nanosized and micron-sized materials. This family of materials is referred to as QuShell. QuShell is a trademark of QuShell LLC, a Delaware limited liability company.

In one aspect, the disclosure relates to a method of manufacturing a material. The method includes making a powder of one or more oxygen containing minerals; mixing the powder either with a water solution of organic and/or inorganic acid to form an acidic slurry, or with water to form a hydrated basic slurry; and curing the slurry to form a solid. In one embodiment, the powder comprises nanoscale particles, or microscale particles, or a mixture of nanoscale particles and microscale particles.

In one embodiment, the one or more oxygen containing minerals are members of the group including sulfates, phosphates, carbonates, silicates, limestone, granite, other minerals, and aluminosilicates of magnesium, or of calcium, or of other minerals. In one embodiment, the powder consists of nanoscale particles with an average particle size of 2 to 3 nanometers.

In one embodiment, the method further includes after the slurry is formed and before it is cured into a solid, adding one or more other materials to the slurry. Optionally, the one or more other materials are members of the group including powders, fibers, steel rebars, sheets of polymer, glass, carbon materials, carbon fibers, and glass fibers.

In one embodiment, the method further includes after the slurry is formed, and before it is cured into a solid, coating a surface with the slurry; and curing the slurry coating to form a solid coating on the coated surface. Optionally, the surface is a surface of a material that is a member of the group including metal, polymer, glass, ceramic, concrete, steel reinforced concrete, carbon fiber, and other material.

In one embodiment the surface is the surface of a component of infrastructure. The infrastructure is a member of the group including buildings, skyscrapers, bridges, airports, roads, and other infrastructure.

In one embodiment, the coated surface is the interior surface of a drilled hole for a well of oil, gas, or other resources, and the cured slurry forms a solid liner in the drilled hole for the well.

In one embodiment, the method further includes after the slurry is formed and before it is cured into a solid, pouring the slurry into a form in the shape of a component of infrastructure, wherein the infrastructure is a member of the group including buildings, skyscrapers, bridges, airports, roads, and other infrastructure.

In another aspect, the disclosure relates to a solid composition including a nanoscale powder of one or more oxygen containing materials, cured with either a water solution of organic and/or inorganic acid, or with water. The solid composition has at least one performance characteristic in the group including density less than conventional concrete, density less than 1.6 g/cm³, non-flammable, structurally stable above 700° celsius, compression strength from 3,000 psi to 13,000 psi, neutral pH or weakly acidic, and tensile strength greater than conventional concrete. The composition is resistant to one or more actions in the group comprising: corrosion, erosion, scratching, photobleaching, oxidation, indentation, penetration by oil or water, absorption of salts, dissolution, and swelling.

In one embodiment, the solid composition is bonded to one member of the group including concrete, steel rebar, glass fibers, carbon fibers, metal, polymer, or ceramic. In yet another aspect, the disclosure relates to a composition, comprising a chemical formula of

(MO)ᵤ.(M₂O₃)_{w}.(MO₂)ₓ.(M₂O₅)_{y}).(MO₃)_{z}.(H₂O)ₙ

wherein each of u, w, x, y and z is in a range of 1-100, and n is in a range of 0-1000, wherein M represents a mineral including metal or nonmetal, and O represents oxygen.

In one embodiment, M in the M₂O₃ is any element with a +3 valence including cobalt, a rare earth, iron, or nickel.

In one embodiment, M in the MO is any element with a +2 valence including magnesium and calcium.

In one embodiment, M in the MO₂ is any element with a +4 valence including silicon, germanium, titanium, or zirconium.

In one embodiment, M in the M₂O₅ is any element with a +5 valence including vanadium, niobium, tantalum, antimony, arsenic, or phosphorous.

In one embodiment, M in the MO₃ is any element with a +6 valence including chromium, molybdenum, or tungsten.

In one embodiment, each of the MO, MO₂, M₂O₃, M₂O₅, and MO₃ are a monomer, a dimer, an oligomer, or a polymer.

Embodiments of the disclosure relate generally to formulations and methods for nano-materials. Embodiments include a combination of a powder of nanoparticles of a mineral, mixed into a basic slurry with water, or mixed into an acidic slurry with a water solution of an organic or inorganic acid, and cured into a solid at ambient temperature and pressure. Further embodiments include other methods of manufacture and use. Product embodiments include, for example, replacements for conventional steel reinforced concrete in infrastructure, coatings retro-fitted to existing conventional infrastructure components, and bore hole liners in oil and gas wells.

These and other aspects of the disclosure are further described below. Without intent to limit the scope of the disclosure, exemplary instruments, apparatus, methods and their related results according to the embodiments of the disclosure are given below. Note that titles or subtitles may be used in the examples for convenience of a reader, which in no way should limit the scope of the disclosure. Moreover, certain theories are proposed and disclosed herein; however, in no way they, whether they are right or wrong, should limit the scope of the disclosure so long as the disclosure is practiced according to the disclosure without regard for any particular theory or scheme of action.

### Formula for QuShell Composition

The general chemical formula for the QuShell composition may be as follows:

(MO)ᵤ₍ᵤ₌₁₋₁₀₀₎.(M₂O₃)_{w(w=1-100)}.(MO₂)ₓ₍ₓ₌₁₋₁₀₀₎.(M₂O₅)_{y(y=1-100)}.).(MO₃)_{z(z=1-100)}(H₂O)_{n(n=0-1,000)}

In this formula, M represents a mineral including metal or nonmetal, and O represents oxygen. For M₂O₃, M is any element with a +3 valence, such as cobalt, a rare earth, iron, or nickel. Oxygen has a −2 valence.

For MO, the M may be any element with a +2 valence such as magnesium and calcium. For MO₂, the M may be any element with a +4 valence, such as silicon, germanium, titanium, zirconium, etc. The M in the M₂O₅ may be any element with a +5 valence, such as vanadium, niobium, tantalum, antimony, arsenic, phosphorous, etc. For MO₃, the M may be any element with a +6 valence, such as chromium, molybdenum, tungsten, etc.

The MO, MO₂, M₂O₃, M₂O₅, and MO₃ may be a monomer, a dimer, an oligomer, or a polymer.

Lead at a +2 or +4 valence, or a heavier element of the +2, +3, +4, +5, and +6 valences, may be used for compositions in applications requiring electromagnetic shielding or radiation shielding, even though lead is toxic. For neutron shielding compositions, boron with a +3 a valence may be used, which is not toxic.

This application describes curing minerals including oxides and nonoxides to form the QuShell composition. Generally, the minerals may be nanosized and micron-sized binders that undergo hydration when combined with the water during the curing process, without the need of dehydration to remove the water.

This is an empirical formula representing a spectrum of embodiments of the formulation of the powders (no water) or cured composition (with water) across a wide mixing ratio between the powders and water. That is, for every 1 to 100 MO units, there may be 1 to 100 M₂O₃ units, 1 to 100 MO₂ units, 1 to 100 M₂O₅ units, 1 to 100 MO₃ units, and 0 to 1000 units of water.

This may be representative of the ingredients to make the QuShell composition. Basically, to make the QuShell composition, one may add minerals and water in ratios that conform to the ranges of the formula. By varying the ratios of the species, one may tune the characteristics of specific embodiments to optimize specific uses.

Conventional Portland cement and other conventional cements have a high pH and are hence very high in alkalinity. This makes them corrosive, and they can dissolve glass and many minerals. This has the effect, for example, of preventing use of glass fibers in Portland cement. On the other hand, the QuShell composition is tunable from the weakly acidic to the pH neutral. Hence the QuShell composition avoids these corrosive and destructive aspects of conventional cement, and permits the addition of glass fibers and other minerals to the cement.

Conventional ceramics needs a high-temperature firing in a kiln. In contrast, the QuShell materials allow the curing and setting at ambient temperatures and pressures, and the curing time and setting time can be widely tunable from minutes to hours, in order to reach the mechanical compression strength from 3,000 psi to 15,000 psi and beyond.

### Methods of Manufacture

FIG. 1 is a diagram of various method embodiments described herein. Various embodiments of the QuShell material may be made by first making (110) a powdery form of one or more minerals, such as for example, sulfates, phosphates, carbonates, silicates, limestone, granite, other minerals or aluminosilicates of magnesium, calcium, or other minerals. Nanoscale (i.e. nanometer scale) powders are preferred, but microscale (i.e. micron scale) powders may also be used. The nanoscale and microscale powder maybe made, for example, by ball milling the mineral over extended periods of time, until the desired particle size is achieved.

Then, the powder may be mixed (120) with a water solution of organic and/or inorganic acid, or suspension of weakly acidic or pH-neutral compound or mixture, or alternatively the powder may be mixed (130) with water to form a hydrated slurry of nanoparticles and/or microparticles. The slurry of nanoparticles and/or microparticles may be a hydroxide (i.e. basic) slurry of the powders with water, or a weakly acidic or pH-neutral slurry of the particles with the weakly acidic or pH-neutral solution or suspension.

Especially desirable qualities of the resulting material may be obtained by using nanoparticle powders with the particle size as small as 2 to 100 nm (2 to 100 nanometers). This may result in an especially strong chemical bonding activity, resulting in an especially strong embodiment of the material, mimicking the formation of seashells and biominerals of many types.

The slurry can then be allowed to cure (140) into a solid at ambient temperature and pressure. The slurry is self-curing at ambient temperature and pressure, and cures faster and slower than conventional concrete. A solid material may be obtained by such curing, with a compression strength over 13,000 psi, contrasting the 3,000 to 5,000 psi for conventional concrete in the market.

This method of manufacture uses the nanoparticle surface acidity or basicity in the slurry and the nanoparticle ultrahigh surface energy which is nanoparticle-size dependent, as the working principle of new type to enable the hierarchical nanochemical bonding of new type.

### Additions of Compositing Material

After the QuShell slurry is formed and before it is cured into a solid, the QuShell slurry can be composited (150) with the addition of one or more other materials including, for example, a powder, fibers, steel rebars, sheets of polymer, glass, carbon materials, or carbon fibers, to cure (151) with the added material to provide a final QuShell product within a wide range of targeted ductility, plasticity, strength, permeability, and structure.

### Coating Surfaces

After the QuShell slurry has been made (120), (130), and before it is cured into a solid, and after any of the compositing materials are added, if any compositing materials are to be added (150) at all, then the QuShell slurry material can be coated (160) onto a solid, such as for example a metal, polymer, glass, ceramic, concrete, or carbon fiber. Then the QuShell material may be allowed to cure (170) on the solid. After such curing on the coated solid, the QuShell coated surface will then be enabled to resist, for example, corrosion, erosion, photobleaching, oxidation, scratching, indentation, penetration by oil or water, dissolution, swelling or other undesirable degradation or changes.

### Upgrading Infrastructure: A Replacement for Steel Reinforced Concrete

Embodiments may be used to upgrade infrastructure, for example skyscrapers, bridges, highways, tunnels, stadiums, arenas, and airports, either through the design and original construction phase, or by retrofitting replacement parts, or by reconditioning traditional parts in place.

Long-standing frustrated needs in this area include the fact that 40% of man-made greenhouse gases are emitted from construction materials, for example concrete and steel, and that steel rebar and concrete hybrid parts can degrade in only decades, and that steel rebar and concrete hybrids are too heavy for building super tall structures in many places, as would be desired if possible. Therefore, long-standing frustrated needs exist to reduce greenhouse gases generated by manufactures of construction materials, and to find a replacement for steel rebar and concrete hybrids that will not degrade so fast, and to find construction materials that are stronger and lighter to replace steel rebar and concrete hybrids.

Various embodiments may be used to replace conventional steel rebar and concrete hybrids in infrastructure, for example, in skyscrapers, bridges, highways, tunnels, stadiums, arenas, and airports.

After the slurry is made at steps (120), (130) and before the slurry is cured into a solid, and after any other materials are added to the slurry, if any other materials are added (150) to the slurry, then the slurry may be poured (200) into a form in the shape of a component of infrastructure, such as for example, structural components of buildings, bridges, skyscrapers, roads, tunnels, or other infrastructure. Then the slurry may be allowed to cure (210) to form the component of infrastructure.

Advantages of QuShell embodiments compared to conventional concrete, when used in this way to upgrade infrastructure, include: QuShell is about one third the cost of conventional concrete; production of the QuShell replacement emits no carbon dioxide; the QuShell material is about 5 times stronger than conventional concrete; no steel rebars are required in the substitute QuShell components (which makes them lighter and cheaper); QuShell is corrosion free, nonporous, and expected therefore to last for centuries; QuShell embodiments are relatively light weight; QuShell may be very fast curing, and the curing maybe tunable from minutes to hours; QuShell is non-flammable and structurally stable above 700° C.; QuShell is biosafe; and QuShell is earthquake safe.

For replacing the steel rebars in conventional concrete, low-cost plastic fibers do not work well, because the plastic fibers' thermal expansion coefficient, surface nanometer- and subnanometer-scales structures or lattices are too different from that of the conventional cement. Also, much stronger (although low-cost) glass-fibers, if used to replace steel rebars in conventional concrete, can be instantly damaged by high pH of the wet cement. However, a weakly acidic or pH-neutral QuShell slurry can, while curing, bond strongly with both glass- and plastics-fibers, due to the excellent atomic-scale lattice match, wetting, and bonding at the QuShell-fiber interface. Furthermore, QuShell may slow or prevent the ongoing degradation of conventional concrete and metal infrastructures by putting the low-cost, long-lasting, dense, ceramic-like, lightweight QuShell on the concrete and metal surfaces.

For upgrading infrastructure, conventional concrete and rebar elements may be replaced with all solid QuShell elements in the design phase. Also, QuShell may be applied to existing infrastructure, for example by applying a QuShell slurry, before curing, to the outside of aging elements of conventional concrete or steel, to repair spalling concrete and to cover exposed rusting rebar, or for other purposes.

This can retro-fit the QuShell as surface-coating on steel reinforced concrete members, and when rebars are imbedded in QuShell material before curing.

### The New Hierarchical Nanochemical Bonding Science Involved in the QuShell

The nanoparticles and microparticles in the composition may bond together at the points of contact, leaving voids between these bonded particles. These voids may be filled by smaller nanoparticles leaving smaller voids between the smaller nanoparticles, and the smaller voids may be filled by even smaller cations and anions. These three sizes of particles may then be found together in the composition, which supports a new Hierarchical Nanochemical Bonding Science.

For example, four particles of 10-nanometer particles may form a tetrahedral void, or six particles of 10-nanometer particles may form a hexahedral void, and each such void can be filled by many cations and anions of smaller sizes. Four or six of 10-micron particles can form the similar voids but 1,000 times bigger, and each such larger void can be filled by hundreds of the 10-nanometer particles.

The composition, using nanoparticles that are smaller than the larger particles that are found in conventional cement, has a different surface chemistry from conventional cement, with different characteristics regarding the hierarchical chemical bonding science, surface acidity- and basicity-tuning, structural and compositional versatility, catalytic effects, solubility, dispersity and diffusivity in water, and speed of reaction and curing.

Some of the most difficult problems with steel rebars in conventional concrete involve basic materials chemistry; that is, the surface rust of steel rebars has many chemical formulas, crystal lattices (or phases), porous structures, and mechanical properties, and the ion oxides may be in either dehydrated or hydrated forms. However, the QuShell's weakly acidic surface may slightly dissolve any metal surface rust, turning the rust to new nanoparticles acting as the strong binder between the metal and QuShell, which expands the Hierarchical Nanochemical Bonding Science to the development of new Interfacial Chemistry in Compositing.

### The Product Produced

In an embodiment, the QuShell composition may comprise: a nanoscale powder of one or more oxygen containing materials, cured with either (1) a water solution of organic and/or inorganic acid, or (2) water, or (3) a water suspension of a powdery matter; wherein the solid composition has at least one performance characteristic in the group comprising: density less than conventional concrete, density less than 1.6 g/cm³, non-flammable, thermally stable above 700° C., pore size of less than 1.5 nanometers, compression strength of at least 13,000 psi, neutral or acidic pH, and tensile strength greater than conventional concrete; and wherein the composition is resistant to one or more actions in the group comprising: corrosion, erosion, scratching, photobleaching, oxidation, indentation, penetration by oil or water or gas, absorption of salts, dissolution, and swelling.

Furthermore, the QuShell embodiment may be bonded to one member of the group comprising: concrete, steel rebar, glass fibers, carbon fibers, metal, polymer, or ceramic.

### Other Methods of Manufacture

FIG. 4 shows another example of methods to manufacture the QuShell compositions in the following:

Step 1: mix and dissolve (401) a first powder either into water or into a weakly acidic water solution. The powder may be mixed (120) with a water solution of organic and/or inorganic acid, or alternatively the powder may be mixed (130) with water to form a hydrated slurry of nanoparticles and/or microparticles. The slurry of nanoparticles and/or microparticles may be a hydroxide (i.e. basic) slurry of the powders with water, or an acidic slurry of the powders with the acidic solution. The microparticles for example may have an average size of 5 to 20 microns, and the actual sizes can vary over a wide range, since all the particles are not the same size. These particles may be rod shaped or spherical. The powder may be a mineral powder. A second mineral powder additive may then be mixed in with this step, and the additive may be a metal oxide such as M₂O₃, MO₂, M₂O₅, and MO₃ in the hydrated form.

The water solution from Step 1 may contain water and dissolved M₂O₅. The M₂O₅ can be entirely dissolved in the water (not remain in particle form) or to form a dimer or an oligomer in the water. The water solution may be obtained as a pre-mix. The M in the M₂O₅ may be any element with a +5 valence, and may be a monomer, a dimer, an oligomer, or a polymer.

Step 2: after Step 1, add dry powdery additive A (402) to the water solution in step 1 to form a slurry of nanoparticles and microparticles. The particle size of the dry powdery additive A may be in the average size range of 4 to 10 microns, although the particles can contain a distribution of sizes including a percentage of nanoparticles of 100 nm or smaller.

Step 3: mix a mineral W (403) into the slurry resulting from Step 2. The mineral W may be a compound between MO and MO₂, such as MgO.SiO₂, CaO.SiO₂, ZnO.SiO₂, etc. The mineral W may be of average micron size, for example, about 4 microns average size with a percentage distribution of nanometer-sized particles.

The particle shape may be spherical, or rod-shaped, or a mixture of the rod-shaped and the spherical. The rod-shaped particles may be preferred more than the spherical particles. This is because the inter-bonding involves only four to six surface point-contacts on each of these bonded spherical particles, but four to six lines of many such surface point-contacts on each of these bonded rods.

Asbestos in most cases should not be used.

Step 3 should not be delayed too long after Step 2, because the slurry resulting from Step 2 may clump up and lose its nanoscale characteristics if there is too much delay. At higher temperatures there should be even less delay after Step 2, because the clumping is faster at the elevated temperature.

Step 4: Step 4 is optional and consists of adding (404) additive B, as a retardant to slow down the curing process. Additive B may be an inorganic mineral, typically a powder of M₂O₃. Additive B, if used, should be mixed into the result of Step 2 at slow RPMs. Additive B is an M mineral with a +3 valence.

Step 5: Step 5 is also optional and consists of adding (405) an additive C, which is an organic compound to slow down the curing process. A wide range of materials may be use for additive C to form a polymer surface that bonds with the QuShell composition. Additive C may contain functional groups such as the epoxy, hydroxyl, carboxylate, amine, or glycol, and these functional groups along the polymer backbone may bond with the QuShell. For high temperature applications, polymeric additive C may not be used because they will melt or be decomposed at the high temperature. In some applications, organic additive C should be avoided, since the nanoparticles in QuShell are catalysts to degrade polymers into microparticles and nanoparticles that can leak easily into the environment to contaminate the environment.

Step 6: In Step 6, stir the mixture (406) resulting from Step 3. The mixture should be stirred longer than conventional cement, for example for about five minutes or more. The mixture should be stirred quickly, to keep the particles in a small size, but should not be stirred too quickly in order to avoid air bubbles forming in the mixture. The stirring should be continuous, since the mixture may start to gel (cure) quickly after the stirring is stopped.

Step 7: Step 7 consists of pouring (407) the results of the preceding steps into a molding or extruding equipment. This may form components of large size, such as roof components or bulletproof vest components. This step may also be used for packaging of integrated circuit IC chips, wall panels with batteries inside the panels, or with telecom equipment inside wall panels. Contrary to conventional concrete containing steel rebars, radio frequencies (RFs) cannot pass through such components. Also these components may be molded with internal steel reinforcement rods, that is rebars, for structures if not for supporting the RF signal penetration, or they may be molded into structural components without re-bars. These components may be molded with optical fibers inside, so that the structure transmits light, or to form optical telecom LiFi networks. Also, these components may be molded with integrated glass fibers.

Step 8: Step 8 consists of leaving (408) the results of previous steps to cure over time. The length of time required for curing is tunable depending on the ingredients and relative percentages of the ingredients used in the formulation.

Fast curing may be obtained, for example for IC integrated chip packaging, in 30 minutes or less. Infrared IR flash heating can make the curing as fast as 1 to 5 minutes.

IR light may penetrate IC packaging to a depth from mm to cm. IR flash heating accelerates curing of the formulation.

The composition may be cured outside in winter for structural components in a time frame depending on the exact recipe of the QuShell formulation and the ambient temperature. This is different from conventional cement that may not cure easily at temperatures below 50° F. The QuShell compositions can be tuned to cure over a wider range of ambient temperatures and in more varied weather conditions than conventional cement.

After curing, the QuShell composition handles temperature changes better than conventional cement and handles exposure to water better, since water does not penetrate the QuShell material to the extent of conventional concrete.

The QuShell compositions are also more flexible than conventional cement, and may be bonded to flexible fiberglass surfaces.

### A Replacement for Conventional Down Hole Cement

The conventional completion of drilling of wells for oil and gas extraction and other purposes often requires lining the drill hole with conventional cement. This presents several challenges for conventional cement. Downhole temperatures and pressures tend to be high, and conventional cement has a long curing time and a viscosity that may inhibit transport downhole by gravity.

Various embodiments of QuShell may provide a superior replacement for conventional down-hole cement. Various embodiments of QuShell provide new formulations and methods for replacing downhole cement, which are effective to optimize operation within the wide variance of underground chemical and physical conditions during and after drilling and fracking operations.

Specific formulations of QuShell can be tuned from the weakly acidic to the pH-neutral, in order to match the characteristics needed for the downhole pH. In contrast, conventional concrete typically has a high pH on the surface. This can induce unwanted reactions with the acidic minerals and acidic underground water often found downhole, in a manner similar to an acid-base neutralization reaction. This acid-base interaction can weaken the underground structure of geologic strata and cause earthquakes. Therefore, QuShell can help to reduce fracking induced earthquakes, in a variety of ways.

After the slurry is made but before it is cured, the slurry may be coated (180) on the interior surface of the bore hole of an oil or gas well, or other well, and allowed to cure (190) to form a solid liner to the interior of the bore hole.

The QuShell material is so dense and non-porous that small hydrocarbon molecules and much smaller salts (i.e. inorganic cations and anions) may not diffuse into and penetrate through QuShell. In contrast, the structure of conventional cement used to line bore holes is full of interconnected and isolated pores, in all shapes and sizes, that can allow hydrocarbon molecules and salt cations and anions to diffuse and penetrate the conventional cement. Therefore, QuShell can act as an underground barrier or shield to line a bore hole or otherwise, that is more stable than conventional cement.

The high inner volume and surface area of the pores of conventional cement, much like that of strong absorbers (e.g. charcoal, and activated carbon), can enable the pores to strongly (i.e. near irreversibly) adsorb foreign salts and small hydrocarbon molecules, using both chemical and physical adsorptions. In contrast, the dense QuShell structure with negligible small pores adsorbs little or none of the hydrocarbons and salts found in oil or gas wells.

Whenever the pressure is reduced in a drill hole with a conventional cement liner, the hydrocarbon and gas molecules trapped in the conventional cement can expand to break the cement structure, thus degrading the conventional liner. However, the post-curing QuShell, by absorbing little to none of the hydrocarbons and salts, is not as sensitive to pressure and temperature changes.

Also, the sharp edge of the cement pore mouth can act as a reactive catalyst to catalyze many unwanted kinds of reactions of hydrocarbons and salts, especially under the high temperature and pressure found down the drilling hole to further enlarge the pore. These reactions can degrade the conventional liner. However, the dense QuShell surface with negligible pores has little such catalyst effect.

### Various Distinctions of QuShell Versus Conventional Cement

Conventional cement releases CO₂ into the atmosphere during its process of manufacture. However, the QuShell composition does not release CO₂ during the process of its manufacture.

The QuShell composition resists dissolution by acid rain, whereas conventional Portland cement dissolves in acid rain. QuShell is resistant to weak acid environments.

Conventional cement is strongly basic, whereas the QuShell composition is not basic.

QuShell that Floats

Water has a density of 1 g/cm³, whereas the QuShell composite may have, in various embodiments, a density of about 1.6 g/cm³, which is about half the density of conventional cement. The formulation of QuShell can be modified in manufacturing to be less dense than water in order to float on water. This is done by using materials lighter than water in place of mineral W, such as silica fume or fumed silica from 1 to 100%. Silica fume has a general form of a hollow silica ball, and is of density lower than that of water.

The QuShell composite may be formulated to be in the range from mildly acidic to neutral pH. On the other hand, conventional Portland cement is highly basic.

### QuShell Vehicle Body Parts

The QuShell composition by itself may be stiff, similar to conventional Portland cement. However, fiberglass or other flexible material may be added to the QuShell composition slurry prior to curing, to make a solid material after curing have a flexible structure and rock-hard surface.

In one embodiment, a vehicle body part may be made out of fiberglass fabric. Then, the QuShell slurry prior to curing maybe sprayed or molded onto the fabric. The QuShell bonds to the fabric in the curing process, resulting in a flexible body part with a hard QuShell surface.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. A method of manufacturing a composition with hierarchical nanochemical bonding, comprising:
making a powder of one or more oxygen containing minerals;
mixing the powder either with a water solution of organic and/or inorganic acid to form an acidic slurry, or with water to form a hydrated basic slurry; and
curing the slurry to form a solid;
wherein the powder comprises nanoscale particles, or microscale particles, or a mixture of nanoscale particles and microscale particles.

2. The method of claim 1, wherein the one or more oxygen containing minerals are members of the group comprising: sulfates, phosphates, carbonates, silicates, limestone, granite, other minerals, and aluminosilicates of magnesium, or of calcium, or of other minerals.

3. The method of claim 1, wherein the powder comprises nanoscale particles with an average particle size of 1-10 nanometers.

4. The method of claim 1, further comprising:
after the slurry is formed and before it is cured into a solid, adding one or more materials to the slurry.

5. The method of claim 4, wherein the one or more materials are members of the group comprising: powders, fibers, steel rebars, sheets of polymer, glass, carbon materials, carbon fibers, and glass fibers.

6. The method of claim 1, further comprising:
after the slurry is formed, and before it is cured into a solid, coating a surface with the slurry; and
curing the slurry coating to form a solid coating on the coated surface.

7. The method of claim 6, wherein the surface is a surface of a material that is a member of the group comprising: metal, polymer, glass, ceramic, concrete, steel reinforced concrete, carbon fiber, and other material.

8. The method of claim 6, wherein the surface, wherein the surface is the surface of a component of infrastructure.

9. The method of claim 8, wherein the infrastructure is a member of the group comprising: buildings, skyscrapers, bridges, airports, roads, and other infrastructure.

10. The method of claim 6, wherein the coated surface is an interior surface of a drilled hole for a well of oil, gas, or other resources, and wherein the cured slurry forms a solid liner in the drilled hole for the well.

11. The method of claim 1, further comprising:
after the slurry is formed and before it is cured into a solid, pouring the slurry into a form in the shape of a component of infrastructure, wherein the infrastructure is a member of the group comprising:
buildings, skyscrapers, bridges, airports, roads, and other infrastructure.

12. The composition made by the method of claim 1.

13. The composition made by the method of claim 5.

14. The solid coating on the surface made by the method of claim 6.

15. The solid coating on a component of infrastructure made by the method of claim 8.

16. The solid liner of a drilled well hole made by the method of claim 10.

17. The solid component of infrastructure made by the method of claim 11.

18. A composition, comprising:
a nanoscale powder of one or more oxygen containing materials, cured with either a water solution of organic and/or inorganic acid, or with water;
wherein the composition has at least one performance characteristic in the group comprising: density less than conventional concrete, density less than 1.6 g/cm³, non-flammable, structurally stable above 700° C., compression strength from 3,000 psi to 13,000 psi, neutral pH or weakly acidic, and tensile strength greater than conventional concrete; and
wherein the composition is resistant to one or more actions in the group comprising: corrosion, erosion, scratching, photobleaching, oxidation, indentation, penetration by oil or water, absorption of salts, dissolution, and swelling.

19. The composition of claim 17, wherein the composition is configured to be bonded to one member of the group comprising: concrete, steel rebar, glass fibers, carbon fibers, metal, polymer, or ceramic.

20. A composition, comprising:
a chemical formula of
(MO)ᵤ.(M₂O₃)_{w}.(MO₂)ₓ.(M₂O₅)_{y}).(MO₃)_{z}.(H₂O)ₙ
wherein each of u, w, x, y and z is in a range of 1-100, and n is in a range of 0-1000, wherein M represents a mineral including metal or nonmetal, and O represents oxygen.

21. The composition of claim 19,
wherein M in the M₂O₃ is any element with a +3 valence including cobalt, a rare earth, iron, or nickel;
wherein M in the MO is any element with a +2 valence including magnesium and calcium,
wherein M in the MO₂ is any element with a +4 valence including silicon, germanium, titanium, or zirconium;
wherein M in the M₂O₅ is any element with a +5 valence including vanadium, niobium, tantalum, antimony, arsenic, or phosphorous; and
wherein M in the MO₃ is any element with a +6 valence including chromium, molybdenum, or tungsten.

22. The composition of claim 19, wherein each of the MO, MO₂, M₂O₃, M₂O₅, and MO₃ are a monomer, a dimer, an oligomer, or a polymer.
